(19) United States
(12) Patent Application Publication
(10) Pub. No.: US 2010/0200333 A1
(43) Pub. Date: Aug. 12, 2010

(54) ASCENDER ON A ROPE WITH INTEGRATED GRIP

(75) Inventors: Alain MAURICE, Saint Hilaire Du Touvet (FR); Paul PETZL, Barraux (FR)

Correspondence Address: OLIFF & BERRIDGE, PLC, P.O. BOX 320850, ALEXANDRIA, VA, 22320-4850, US

(73) Assignee: ZEDEL, Crolles (FR)

(21) Appl. No.: 12/702,772

(22) Filed: Feb. 9, 2010

(30) Foreign Application Priority Data
Feb. 9, 2009 (FR) 09 00546

(51) Int. Cl. A62B 1/14; A63B 29/02

(52) U.S. Cl. 182/133

(57) ABSTRACT

An ascender for a fixed rope comprising a metal flange-plate equipped with a trough for housing the rope and with a swivelling trigger designed to block the rope against the inner surface of the trough when the flange-plate is solicited in the downwards direction. The outside surface of the trough comprises an ergonomic grip for the ascender to be totally held in the hand. The grip extends over the whole length of the trough, and the pivot-pin of the trigger is located at an intermediate level between the opposite ends of the grip.

### BACKGROUND OF THE INVENTION

The invention relates to an ascender for a fixed rope, comprising a metal flange-plate equipped with a trough accommodating the rope, with a swivelling trigger designed to jam the rope against the inner surface of the trough when the flange-plate is solicited in the downwards direction, and with an ergonomic grip for the user to handle the ascender.

### STATE OF THE ART

Ascenders with a grip for secured progression are provided for climbing on a single fixed rope of 8 mm to 13 mm in diameter. The body of the ascender is generally made from aluminium alloy and the trigger is made from chromium steel. It is known for the grip to be in the form of a gripping handle arranged under the ascender. The grip and body of the ascender are manufactured by cutting and folding of a single aluminum alloy sheet. The grip is held at a level that is offset with respect to the jamming zone of the rope in the trough of the ascender. The overall dimensions of this type of progression ascender are rather large.

### OBJECT OF THE INVENTION

The object of the invention consists in providing an ascender on a fixed rope that is optimum and comfortable for the user to handle, and that is of reduced size.

The ascender according to the invention is characterized in that the grip extends over the whole length outside the trough and that the pivot-pin of the trigger is located at an intermediate level between the opposite ends of the grip.

The ascender can be easily held in the user's hand with comfortable and efficient gripping.

According to a preferred embodiment, the grip comprises a bottom stop for the user's hand to rest against and an upper protuberance acting as a finger brace.

The grip can be secured on the trough by fixing means or it can form an integral part of the metal flange-plate.

The grip is preferably made from molded plastic.

### BRIEF DESCRIPTION OF THE DRAWINGS

Other advantages and features will become more clearly apparent from the following description of an embodiment of the invention given for non-restrictive example purposes only and represented in the accompanying drawings, in which:

FIG. 1 is an exploded perspective view of the ascender with a grip according to the invention;

FIGS. 2 to 4 represent elevational views of the ascender with a grip, respectively in the active position, in the intermediate open position and in the inactive position of the trigger with spikes.

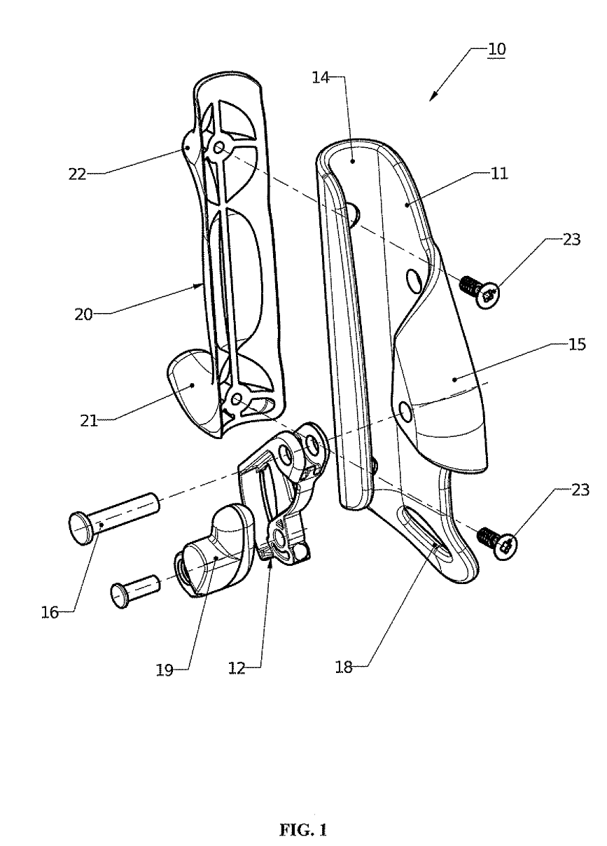

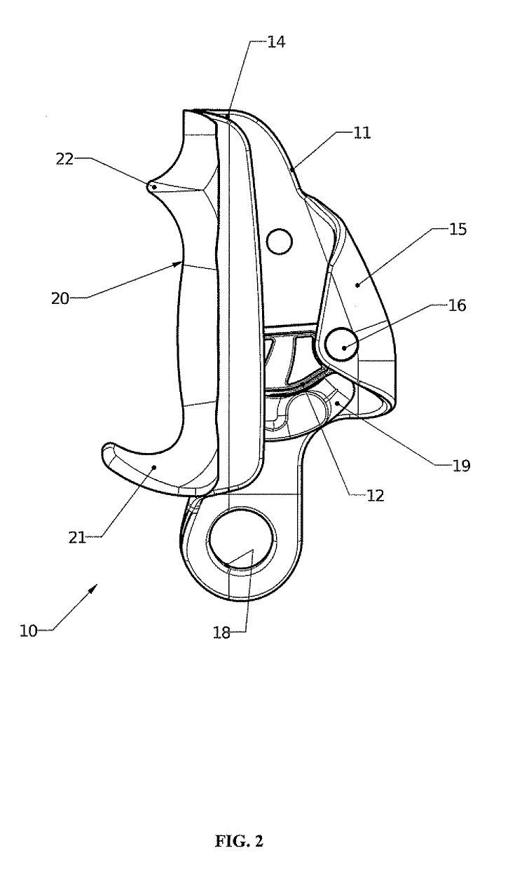

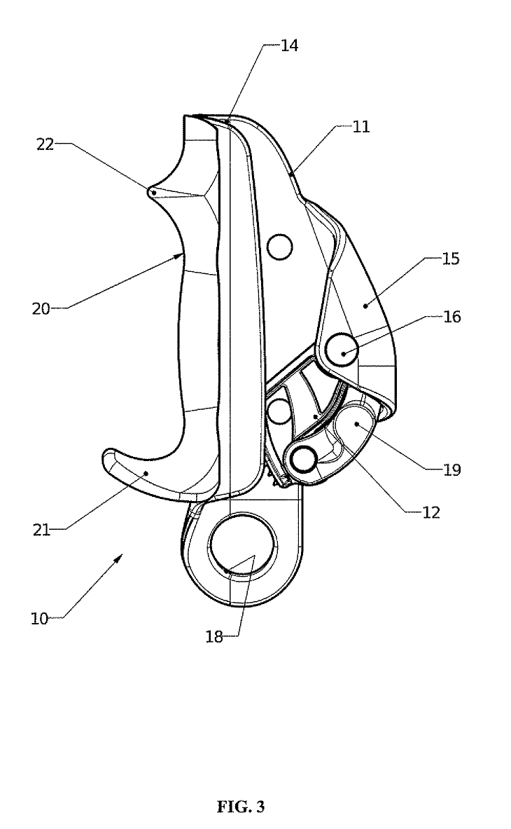

### DETAILED DESCRIPTION OF THE INVENTION

In the figures, an ascender 10 for ascending on a fixed rope comprises a fixed flange-plate 11 and a movable trigger 12 equipped with a jamming surface with spikes 13 to block the rope in the downwards direction.

Flange-plate 11 comprises a straight U-shaped guiding trough 14 enabling the rope to run with sliding when the user progresses in the upwards direction. A half-open U-shaped clamp 15 bearing the transverse pivot-pin 16 of swivelling trigger 12 is located opposite trough 14.

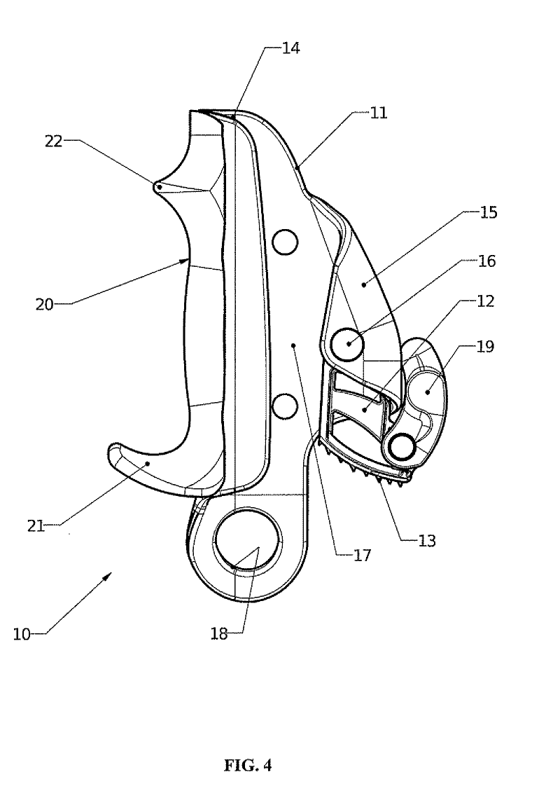

A space 17 is arranged between trough 14 and clamp 15 for the rope to be able to run through after trigger 12 has been moved to the inactive position of FIG. 4.

The base of flange-plate 11 is provided with a circular hole 18 to secure a carabiner. Trigger 12 with inclined spikes 13 is of the type described in the document FR 2600898. An operating lever 19 is articulated on trigger 12 to move the latter to the inactive position and to keep the latter in this position in stable manner by latching the latter at the rear of clamp 15.

An ergonomic handle 20 is fixed onto flange-plate 11 along the outer side of trough 14. It extends over the whole length of trough 14 being delineated by a bottom stop 21 and an upper protuberance 22. Bottom stop 21 enables the user's hand to rest thereon, whereas protuberance 22 acts as a finger brace for optimum grip of the ascender in the user's hand. Pivot-pin 16 of trigger 12 is located at an intermediate level between the opposite ends of grip 20.

Grip 20 is preferably made from molded plastic and is fixed onto trough 14 by screws 23 or by any other fixing means. Metal flange-plate 11 is achieved by cutting and folding a sheet of aluminum alloy or of stainless steel.

According to an alternative embodiment, grip 20 forms an integral part of flange-plate 11 following a molding operation.

1. An ascender for a fixed rope, comprising a metal flange-plate equipped with a trough accommodating the rope, with a swivelling trigger designed to jam the rope against the inner surface of the trough when the flange-plate is solicited in the downwards direction, and with an ergonomic grip for the user to handle the ascender,
wherein the grip extends over the whole length outside the trough, and the pivot-pin of the trigger is located at an intermediate level between the opposite ends of the grip.

2. Ascender according to claim 1, wherein the grip is provided with a bottom stop for the user's hand to rest against and an upper protuberance acting as a finger brace.

3. Ascender according to claim 1, wherein the grip forms an integral part of the metal flange-plate.

4. Ascender according to claim 1, wherein the grip is made from molded plastic.

5. Ascender according to claim 4, wherein the grip is secured to the trough by fixing means.

6. Ascender according to claim 1, wherein the swivelling trigger is provided with a jamming surface with spikes, and with an operating lever to neutralize the ascender in an inactive position when the rope is inserted.
